(19) United States
(12) Patent Application Publication
(10) Pub. No.: US 2021/0383317 A1
(43) Pub. Date: Dec. 9, 2021

(54) ACQUAINTANCES FINDER MECHANISM FOR ARRIVING AT A DYNAMIC DELIVERY LOCATION FOR A BULK PURCHASE

(71) Applicant: International Business Machines Corporation, Armonk, NY (US)

(72) Inventors: Mauro Marzorati, Lutz, FL (US); Shikhar Kwatra, Durham, NC (US); Hemant Kumar Sivaswamy, Pune (IN); Adam Lee Griffin, Dubuque, IA (US)

(21) Appl. No.: 16/891,642

(22) Filed: Jun. 3, 2020

(51) Int. Cl. G06Q 10/08; G06Q 30/06

(52) U.S. Cl. CPC G06Q 10/0832; G06Q 30/0633; G06Q 10/08355

(57) ABSTRACT

Bulk product purchasing is optimized by monitoring Internet-of-Things (IoT) devices of various consumers to identify a group of acquaintances associated with a common geographic area, and then ascertaining that there is some common product of interest to the group. If there is a bulk purchase offer available for the common product it is proposed to the group, or a bulk purchase offer is generated in real-time by an eCommerce retailer carrying the product. The system computes a dynamic delivery location within the common geographic area that is convenient to the group. The dynamic delivery location can be influenced by characteristics of the common product (e.g., refrigerated, bulky, etc.) and by available facilities of the acquaintances in the common geographic area. The system thereby presents a huge eCommerce collaboration opportunity and results in a win-win situation for both consumers and eCommerce retailers.

### BACKGROUND OF THE INVENTION

### Field of the Invention

The present invention generally relates to purchasing products via online services (eCommerce), and more particularly to a method of buying and delivering products in bulk.

### Description of the Related Art

The Internet has introduced many changes for consumer spending, chief among these being online shopping, sometimes referred to as eCommerce. Online shopping is a form of electronic commerce which allows consumers to buy goods or services from a seller over the Internet using a web browser, as opposed to shopping at a physical store presence, i.e., a “brick-and-mortar” retailer. In one scenario, consumers find a product of interest by visiting the website of the retailer or by searching among alternative vendors using a shopping search engine, which displays the same product's availability and pricing at different e-retailers. Once a particular product has been found on the website of the seller, online retailers use “shopping cart” software to allow the consumer to accumulate multiple items and to adjust quantities, similar to filling a physical shopping cart or basket in a conventional store. A checkout process follows (continuing the physical-store analogy) in which payment and delivery information is collected. Financial transactions are processed in real-time. Items purchased online are shipped from stores or warehouses directly to the purchaser's home or place of business. As with conventional shopping, online shopping can include bulk purchases (i.e., an unusually large number of the same product) which allow a customer to take advantage of economies of scale.

Currently customers can shop online using a range of different computers and devices, including desktop computers, laptops, tablet computers, smartphones, and smart speakers. These devices are all part of what has become known as the Internet-of-Things (IoT). IoT systems not only facilitate human-computer interactions in the commerce arena, but further enable all sorts of enhanced control such as for products pertaining to smart homes (smart appliances, security systems, ecosystems), vehicle navigation, medical devices, etc. IoT devices are also particularly useful for monitoring consumer behavior including spending habits as well as geographic movements using embedded global positioning system (GPS) capabilities.

### SUMMARY OF THE INVENTION

The present invention in at least one embodiment is generally directed to a method of optimizing a bulk product purchase by identifying a plurality of consumers who are acquaintances based on their electronic device usage, establishing that each of the acquaintances has an association with a common geographic area, ascertaining a common product likely to be purchased by each of the acquaintances, determining a dynamic delivery location within the common geographic area for bulk delivery of the common product, providing a bulk purchase offer of the common product to at least one of the acquaintances, and receiving a purchase confirmation of the bulk purchase offer from that acquaintance. The dynamic delivery location can be based in part on one or more characteristics of the common product, e.g., refrigerated, large volume, large weight or expiration date. The dynamic delivery location can also be based in part on one or more available facilities of the acquaintances, located in the common geographic area. The bulk purchase offer can be a preexisting offer available at an eCommerce retailer or dynamically generated in real-time in response to ascertaining the common product. In one implementation the dynamic delivery location is associated with a specific acquaintance, and a delivery time for the bulk delivery is computed based on prior activity of that acquaintance taking place within the geographic area. The method can allow two (or more) dynamic delivery locations for split delivery of the bulk product purchase.

The above as well as additional objectives, features, and advantages in the various embodiments of the present invention will become apparent in the following detailed written description.

### BRIEF DESCRIPTION OF THE DRAWINGS

The present invention may be better understood, and its numerous objects, features, and advantages of its various embodiments made apparent to those skilled in the art by referencing the accompanying drawings.

FIG. 1 is a block diagram of a computer system programmed to carry out bulk product purchase optimization in accordance with one implementation of the present invention;

FIG. 2 is a pictorial representation of a cloud computing environment in accordance with one implementation of the present invention;

FIG. 3 is a pictorial representation of a vertical city environment having multiple acquaintances associated with a common geographic area in accordance with one implementation of the present invention;

FIG. 4 is a block diagram of a system architecture for carrying out bulk product purchase optimization in accordance with one implementation of the present invention; and

FIG. 5 is a chart illustrating the logical flow for a bulk product purchase optimization process in accordance with one implementation of the present invention.

The use of the same reference symbols in different drawings indicates similar or identical items.

### DESCRIPTION OF THE PREFERRED EMBODIMENT(S)

As eCommerce industries are getting more and more competitive, businesses are trying to find better ways to optimize cost and keep their customers happy. Some of the more common schemes include things like preferred days (or times) of delivery, free delivery, special sales promotions such as “buy one, get one free”, price discounts such as a store credit for spending a minimum amount online, and electronic coupons. While many vendors also give better offers on bulk purchases, it can be difficult for customers to buy excessive quantities of the same product just to save a few bucks. Additionally, as population densities grow in urban areas, there are more opportunities for communal purchasing that have not been realized by online stores.

It would, therefore, be desirable to devise an improved method of optimizing bulk product purchases. It would be further advantageous if the method could leverage existing Internet-of-Things (IoT) technologies to bring customers together and provide greater potential for bulk purchase savings. These and other advantages are achieved in various implementations of the present invention by identifying people trying to buy the same or similar products using the data captured through their registered IoT devices. The bulk purchase item could be, e.g., either a product which is going to need replenishing (e.g., captured by an IoT in the smart refrigerator or cupboard), or a product discerned from cross-talk between people at home. An acquaintance engine arrives at a delivery location for the circle of trust (i.e., friends' network) in a dynamic fashion. For example, the bulk order may be based on user input from IoT devices combined with global positioning system (GPS) tracking. The dynamic delivery location selection can be influenced by other factors such as characteristics of the product (refrigerated, bulky, heavy, etc.) or available facilities of one of the acquaintances located within a common geographic area associated with the acquaintances.

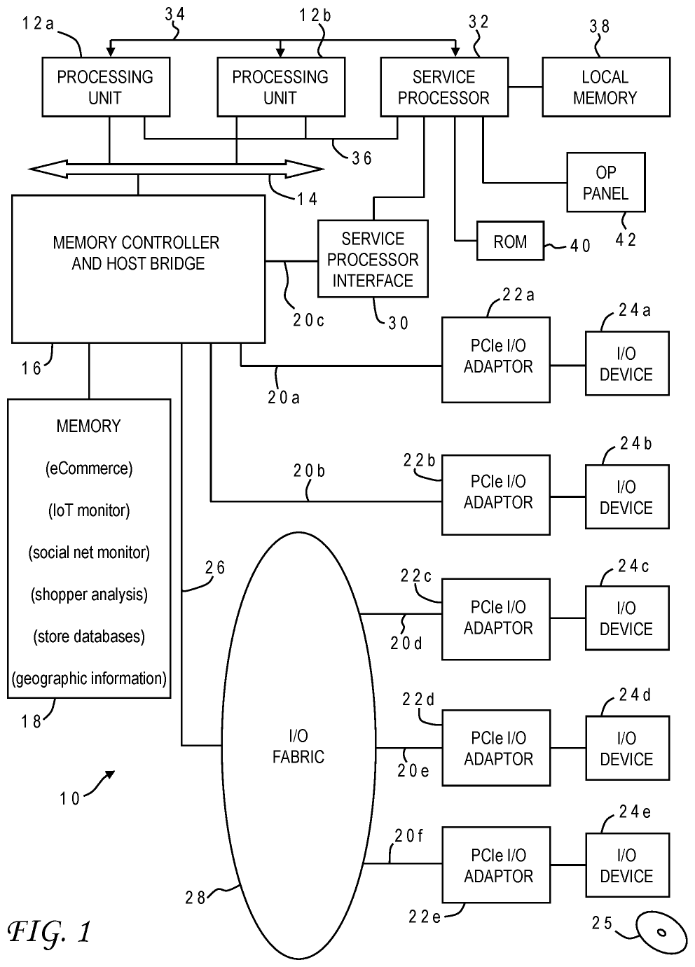

With reference now to the figures, and in particular with reference to FIG. 1, there is depicted one embodiment 10 of a computer system in which the present invention may be implemented to carry out optimization of bulk product purchases. Computer system 10 is a symmetric multiprocessor (SMP) system having a plurality of processors 12a, 12b connected to a system bus 14. System bus 14 is further connected to and communicates with a combined memory controller/host bridge (MC/HB) 16 which provides an interface to system memory 18. System memory 18 may be a local memory device or alternatively may include a plurality of distributed memory devices, preferably dynamic random-access memory (DRAM). There may be additional structures in the memory hierarchy which are not depicted, such as on-board (L1) and second-level (L2) or third-level (L3) caches. System memory 18 has loaded therein one or more applications in accordance with the present invention, such as an eCommerce package, an IoT monitor, a social network monitor, a shopper analysis module, one or more store databases, and a geographic information system.

MC/HB 16 also has an interface to peripheral component interconnect (PCI) Express links 20a, 20b, 20c. Each PCI Express (PCIe) link 20a, 20b is connected to a respective PCIe adaptor 22a, 22b, and each PCIe adaptor 22a, 22b is connected to a respective input/output (I/O) device 24a, 24b. MC/HB 16 may additionally have an interface to an I/O bus 26 which is connected to a switch (I/O fabric) 28. Switch 28 provides a fan-out for the I/O bus to a plurality of PCI links 20d, 20e, 20f These PCI links are connected to more PCIe adaptors 22c, 22d, 22e which in turn support more I/O devices 24c, 24d, 24e. The I/O devices may include, without limitation, a keyboard, a graphical pointing device (mouse), a microphone, a display device, speakers, a permanent storage device (hard disk drive) or an array of such storage devices, an optical disk drive which receives an optical disk 25 (one example of a computer readable storage medium) such as a CD or DVD, and a network card. Each PCIe adaptor provides an interface between the PCI link and the respective I/O device. MC/HB 16 provides a low latency path through which processors 12a, 12b may access PCI devices mapped anywhere within bus memory or I/O address spaces. MC/HB 16 further provides a high bandwidth path to allow the PCI devices to access memory 18. Switch 28 may provide peer-to-peer communications between different endpoints and this data traffic does not need to be forwarded to MC/HB 16 if it does not involve cache-coherent memory transfers. Switch 28 is shown as a separate logical component but it could be integrated into MC/HB 16.

In this embodiment, PCI link 20c connects MC/HB 16 to a service processor interface 30 to allow communications between I/O device 24a and a service processor 32. Service processor 32 is connected to processors 12a, 12b via a JTAG interface 34, and uses an attention line 36 which interrupts the operation of processors 12a, 12b. Service processor 32 may have its own local memory 38, and is connected to read-only memory (ROM) 40 which stores various program instructions for system startup. Service processor 32 may also have access to a hardware operator panel 42 to provide system status and diagnostic information.

In alternative embodiments computer system 10 may include modifications of these hardware components or their interconnections, or additional components, so the depicted example should not be construed as implying any architectural limitations with respect to the present invention. The invention may further be implemented in an equivalent cloud computing network.

When computer system 10 is initially powered up, service processor 32 uses JTAG interface 34 to interrogate the system (host) processors 12a, 12b and MC/HB 16. After completing the interrogation, service processor 32 acquires an inventory and topology for computer system 10. Service processor 32 then executes various tests such as built-in-self-tests (BISTs), basic assurance tests (BATs), and memory tests on the components of computer system 10. Any error information for failures detected during the testing is reported by service processor 32 to operator panel 42. If a valid configuration of system resources is still possible after taking out any components found to be faulty during the testing then computer system 10 is allowed to proceed. Executable code is loaded into memory 18 and service processor 32 releases host processors 12a, 12b for execution of the program code, e.g., an operating system (OS) which is used to launch applications and in particular the bulk product purchasing optimization application of the present invention, results of which may be stored in a hard disk drive of the system (an I/O device 24). While host processors 12a, 12b are executing program code, service processor 32 may enter a mode of monitoring and reporting any operating parameters or errors, such as the cooling fan speed and operation, thermal sensors, power supply regulators, and recoverable and non-recoverable errors reported by any of processors 12a, 12b, memory 18, and MC/HB 16. Service processor 32 may take further action based on the type of errors or defined thresholds.

The present invention may be a system, a method, and/or a computer program product. The computer program product may include one or more computer readable storage media collectively having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer system 10 carries out program instructions for a bulk purchase optimization process that uses novel analytical techniques to manage online purchases for a group of acquaintances. Accordingly, a program embodying the invention may additionally include conventional aspects of various eCommerce tools, and these details will become apparent to those skilled in the art upon reference to this disclosure.

In some embodiments, one or more aspects of the present invention may be carried out using cloud computing. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include various characteristics, service models, and deployment models.

Characteristics can include, without limitation, on-demand service, broad network access, resource pooling, rapid elasticity, and measured service. On-demand self-service refers to the ability of a cloud consumer to unilaterally provision computing capabilities, such as server time and network storage, as needed automatically without requiring human interaction with the service's provider. Broad network access refers to capabilities available over a network and accessed through standard mechanisms that promote use by heterogeneous thin or thick client platforms (e.g., mobile phones, laptops, and personal digital assistants, etc.). Resource pooling occurs when the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). Rapid elasticity means that capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service is the ability of a cloud system to automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models can include, without limitation, software as a service, platform as a service, and infrastructure as a service. Software as a service (SaaS) refers to the capability provided to the consumer to use the provider's applications running on a cloud infrastructure. The applications are accessible from various client devices through a thin client interface such as a web browser. The consumer does not manage or control the underlying cloud infrastructure including network, servers, operating systems, storage, or even individual application capabilities, with the possible exception of limited user-specific application configuration settings. Platform as a service (PaaS) refers to the capability provided to the consumer to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a service (IaaS) refers to the capability provided to the consumer to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models can include, without limitation, private cloud, community cloud, public cloud, and hybrid cloud. Private cloud refers to the cloud infrastructure being operated solely for an organization. It may be managed by the organization or a third party and may exist on-premises or off-premises. A community cloud has a cloud infrastructure that is shared by several organizations and supports a specific community that has shared concerns (e.g., mission, security requirements, policy, and compliance considerations). It may be managed by the organizations or a third party and may exist on-premises or off-premises. In a public cloud, the cloud infrastructure is made available to the general public or a large industry group and is owned by an organization selling cloud services. The cloud infrastructure for a hybrid cloud is a composition of two or more clouds (private, community, or public) that remain unique entities but are bound together by standardized or proprietary technology that enables data and application portability (e.g., cloud bursting for load-balancing between clouds).

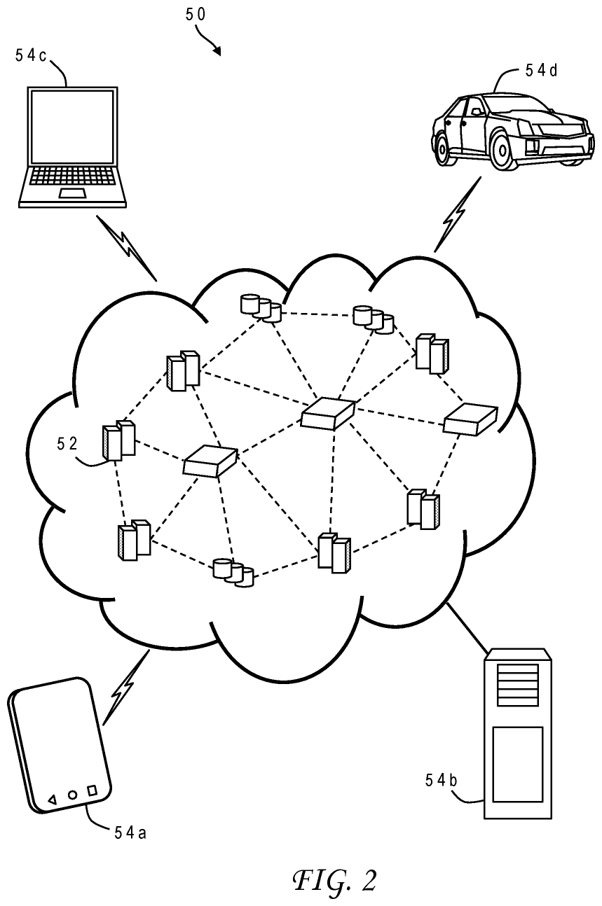

A cloud computing environment is service oriented with a focus on statelessness, low coupling, modularity, and semantic interoperability. The foundation of cloud computing is an infrastructure that includes a network of interconnected nodes. An illustrative cloud computing environment 50 is depicted in FIG. 2. As shown, cloud computing environment 50 includes one or more cloud computing nodes 52 with which local computing devices used by cloud consumers, such as, for example, personal digital assistant (PDA) or cellular telephone 54a, desktop computer 54b, laptop computer 54c, and/or automobile computer system 54d may communicate. Nodes 52 may communicate with one another. They may be grouped (not shown) physically or virtually, in one or more networks, such as private, community, public, or hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54a-54d shown in FIG. 2 are intended to be illustrative only and that computing nodes 52 and cloud computing environment 50 can communicate with any type of computerized device over any type of network and/or network addressable connection (e.g., using a web browser).

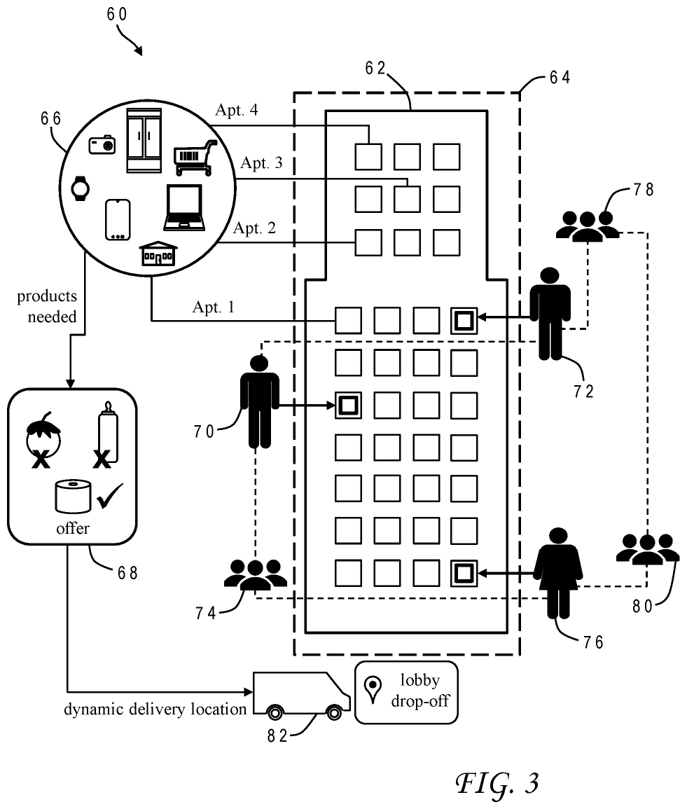

Referring now to FIG. 3, there is depicted one example of a bulk product purchasing environment 60 in accordance with one implementation of the present invention In this example, bulk product purchasing environment 60 is part of a “vertical city”, that is, an urban area with a high population density. Many cities have policies specifically directed to encouraging such upward growth, and discouraging outward, which creates a localized captive audience that the present invention can leverage to the local community's advantage. In some instances these urban vertical cities can be completely contained in a single skyscraper (high-rise building) 62 producing communities and internal economies that need to source products/purchasing power from the outside. In addition to residential spaces, skyscrapers may host offices, temporary living quarters (e.g., hotels), and retail spaces, or even manufacturing facilities. Further to this example, the rough footprint of skyscraper 62 defines a geographic area 64 that can be associated with the various tenants of the building, some of whom are acquaintances. While such vertical cities are considered a prime opportunity for deployment of the present invention, it will become apparent that the present invention is not so limited, and any vicinity can be designated a geographic area common to two or more acquaintances according to system design preferences and/or constraints.

Skyscraper 62 is a smart building having infrastructure and devices that enable and enhance communication and control using various IoT devices 66 of the occupants. IoT devices 66 include without limitation local computing devices, smart home or smart kitchen appliances such as ovens, pantries or refrigerators having built-in sensors, cameras and microphones or other audio/video recording equipment, GPS beacons, personal fitness devices (e.g., wristbands), internet-capable television sets, smartphones, etc. Usage of these various electronic devices is monitored to determine what products 68 have been previously purchased or might be needed by an occupant, or other user consumer habits. This monitoring may include conventional natural language processing that identifies particular products from text input of the users (or from speech-to-text conversion of audio information). Some of the devices can rely on electronic tags (e.g., magnetic strips or RFID markers) attached to various goods to create a digital inventory system. Image recognition software running on the local computing device may also be able to identify various items in camera view. This data is collected for each apartment or unit of skyscraper 62 so it can be associated with a specific person or entity. In the illustrative implementation, a user opts in to the data collection using an appropriate app loaded on the user's smartphone to register with an eCommerce site which then allows data from all of the user's IoT devices to be aggregated.

A monitoring system at a cloud server remote from skyscraper 62 can collect the data. The cloud server may for example be a node 52 of FIG. 2 having an architecture like computer system 10 of FIG. 1, in communication with skyscraper 62 via the Internet. The cloud server can also access other user functions such as social networks to acquire information pertaining to other individuals associated with the user, e.g., online friends or groups on social media platforms. Similar information can be gleaned from other sources such as a user's calendar systems and contact lists. Some apps specifically provide such user associations. This information gathering can be facilitated by other external systems. In this manner, multiple acquaintances can be associated with a single individual by an acquaintance engine running on the cloud server. Some of these acquaintances can have a direct association while others may have indirect associations. For example, an occupant 70 of skyscraper 62 is discerned to have immediate social relations with another occupant 72. Occupant 70 is also discerned to have a first group of other direct acquaintances 74, one of whom has immediate relations with a third occupant 76. Occupant 72 has a more distant link with occupant 76 through a second group of friends 78, one of whom has relations with a third group of friend 80, one of whom has direct relations with occupant 76. The acquaintance engine can thereby make an initial determination that all three of occupants 70, 72 and 76 may be a candidate group of acquaintances for bulk purchasing purposes. The acquaintance engine can seek verification of this grouping from any of the three, and once one of them provides such confirmation the acquaintance engine marks these three as being definite acquaintances. Other methods can be employed to verify suspected acquaintances automatically. In this example, all of the acquaintances are individuals, i.e., real people, but an acquaintance could also be a non-person entity like a business such as a store or restaurant in skyscraper 62.

Once a group of acquaintances is identified, their consumer habits can be correlated to ascertain what products might be of interest to all of them. If the acquaintance engine sees that they have all purchases the exact same product over a recent period of time (say, the last six months), that product can be targeted for a bulk purchase offer. Common products need not be exactly the same, however; they could for example be different brands of a product that is essentially the same, or they could be different types of products that are still considered sufficiently related, particularly those having a high cross-elasticity of demand. Metadata obtained from online searches, historical purchase rates, consumption rates, marketing offers, etc., can also be fed to the acquaintance engine to facilitate the search for products of interest to everyone in the group, or to just a subset. The bulk sale offer could be a pre-existing offer available at an online store, or could be one that is dynamically generated by an e-Commerce retailer in response to a suggestion from the acquaintance engine. The bulk purchase offer can be dynamically generated in real-time, that is, as soon as the bulk product suggestion is made. Multiple bulk purchase offers can be so generated. The cloud server then sends out the most probable lists to the customers for bulk purchase with the best offers configured for customer presentation and consideration. Offers can be combined with other notifications or calendar entries. Different protocols can be used to provide the offers. The cloud server can “push” responses to a client through protocols such as Web Socket that support bi-directional communication between client and server. Many messaging systems support these protocols in their application programming interfaces. Further to the example of FIG. 3, the acquaintance engine has determined that one of the products 68 used by all three of the occupants 70, 72, 76 is toilet paper, and an order for this product is fashioned for submission to the acquaintances.

Once one of the customers in the group assents to the bulk purchase offer (via a conventional notification/messaging system or through the eCommerce retailer's app), the cloud server continues by determining a suitable location for delivery proximate the common geographic area 64; the dynamic delivery location can also be computed in advance of making the offer and included with it. In some implementations, one or more of the acquaintances in the group can opt out of the bulk purchase offer already agreed to by another acquaintance, and the bulk purchase offer may still be effectuated for the remaining individuals. From the data collected by the IoT devices, GPS coordinates, etc., the acquaintance engine will be able to arrive at the most ideal location for product pickup. This decision can include metadata associated with the order such as product handling requirements (e.g., refrigeration, volumetric, weight, expiration dates) as well as available facilities at each participant's dwelling. The order is then shipped to the dynamic delivery location by the eCommerce retailer or a third party delivery service 82. Some implementations may include the ability to split a bulk purchase delivery into multiple lots each having a different pickup location.

The foregoing description can be further understood by reference to a specific example involving three individuals, John, George and Sam who car pool to work every day. Using the information available through their respective IoT devices, the acquaintance engine has flagged these three as possible acquaintances. The IoT devices in this context include an automotive telematics unit in the car they take to work, their various personal mobile devices and laptop computers, a smart watch belonging to John, and a physical fitness wristband belonging to Sam. Each of the individuals has signed up with the eCommerce retailer and registered the various IoT devices. A home's network could also be optionally scanned for a list of other compatible devices to participate and opt in or out of the system. This list could be updated as and when the user adds new IoT devices. Thus, at the end of the registration, the eCommerce site would now be aware of all the possible IoT devices that could be associates with any particular user.

Further to this example, John lives in a unit on the third floor of an apartment building, George lives in a nearby house, and Sam sublets a room in another house near George but a bit further from John. John works at an office, George is a gardener, and Sam is a waitress while going to school. When John, George and Sam are traveling together, the eCommerce software agent installed on their IoT devices transmits GPS coordinates indicating they are in the same area for the same time/space of travel. For example, John, George and Sam travel to their respective work locations every weekday. The time of travel is fixed around 9:00 am and 6:00 μm. The eCommerce agent broadcasts this data stream to the eCommerce cloud server where the eCommerce system performs analytics over these GPS coordinates. At the end of the analysis, the eCommerce system is aware that the IoT devices belonging to John, George and Sam are always in very close vicinity for specific periods of time, along a specific route, five days of the week. Thus, John, George and Sam would initially be flagged as possible acquaintances.

Sam and John go to the neighborhood sports complex for a game of badminton every weekend, which is reported by the smart watch and the e-wristband, and in turn recorded by the eCommerce agent. This secondary association over an extended period of time provides a confirmatory link that allows the agent to move the relationship of Sam and John from possible acquaintances to verified acquaintances. Additionally, cross-device tracking can provide a confirmatory link. Cross-device tracking allows two individuals using different devices to be correlated (see, e.g., the article “Privacy, Cross-device Tracking and the Internet of Things” by Angela Habibi at Contra Costa Lawyer Online http://cclawyer.cccba.org/2016/03/privacy-cross-device-tracking-and-the-internet-of-things/). By listening for the cross-talk between the individuals and analyzing the audio streams, the eCommerce agent determines that George and Sam have multiple conversations (this feature is of course based on the permissions enabled by the users). The agent thus also moves the relationship of George and Sam from possible acquaintances to verified acquaintances. At this point the agent might further infer that these existing verifications justify concluding that John and George are definite acquaintances but just to be sure, the agent prompts John and George in this regard and, upon receiving confirmation from either of them, now lists all three as a tight-knit group (socially and geographically) which is ideal for deployment of the present invention.

The eCommerce agent subsequently analyzes the data streams from these three acquaintances to tag any potential products to be sold. For example, the eCommerce agent notices that Sam makes a monthly grocery purchase at an eCommerce site that usually includes butter. John's smart refrigerator is also providing an indication that he has almost run out of or is currently out of butter. Thus, a group discount offer can be made to both John and Sam where butter can be purchased at a cheaper rate if both buy it or, conversely, one of them makes a bulk purchase. The offer might be made in real-time based on the fact that Sam is currently at a physical grocery store which can fulfill such a bulk product purchase. George can be included in the bulk purchase offer based on his previous purchases, or even if there is no current indication that he wants butter. The offer can be valid for a certain number of days, as John might have to confirm the offer on his cart too. They could additionally leverage a further discount if they opt for delivery at the same location. From dwelling analysis, it can be ascertained that Sam is not a good candidate to receive the bulk order for distribution to John if the order has special requirements such a bulky, refrigeration, etc., because of her limited quarters and there being no refrigerator in her room. The agent therefore suggests a dynamic delivery location of John's apartment, or George's house (if George has opted in) since the location of George's house is intermediate John's apartment and Sam's house. Thus, by analyzing the information from these acquaintances, the system figures out their future requirements to suggest group discounts concentrated to a single delivery location that is able to accommodate the bulk.

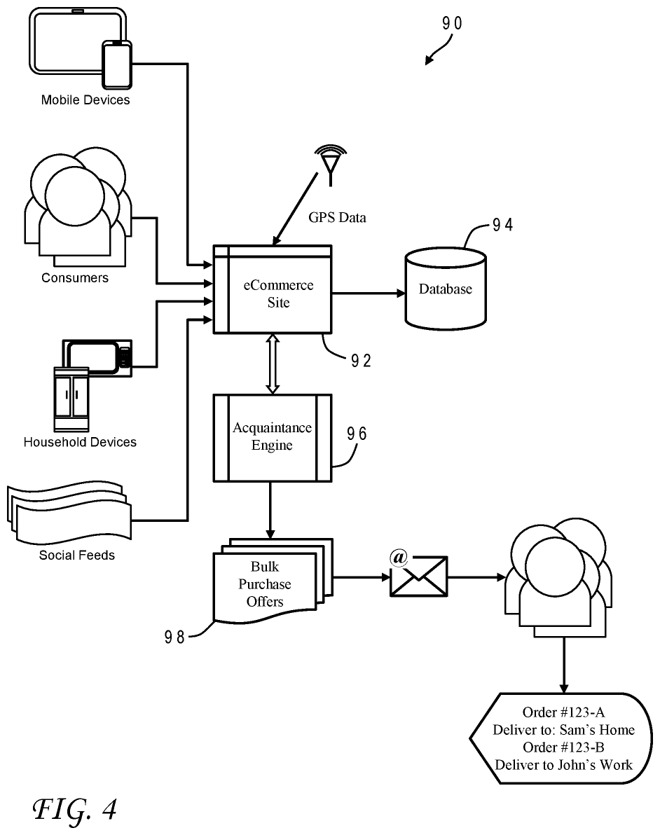

With further reference to FIG. 4, there is depicted a system architecture 90 for carrying out bulk product purchase optimization in accordance with one implementation of the present invention. At the heart of system 90 is the eCommerce site 92 managed by the eCommerce retailer. An appropriate user interface for eCommerce site 92 (e.g., an app or a web page accessed via a web browser) allows consumers to register their various IoT devices, including mobile devices and household devices. The agent running at eCommerce site 92 receives data streams from all of these devices as well as information from the consumers directly. The agent can also monitor social feeds, i.e., notifications, messages and other interactions between the consumers and various social networking platforms. This information, along with correlated GPS data, can be aggregated over time and stored in a database 94, and enables the acquaintance engine 96 to identify multiple consumers that can be considered acquaintances and are associated with a common geographic area.

Acquaintance engine 96 is able to examine the purchasing histories and other consumer habits of individuals in an associated group (also stored in database 94) to identify any bulk product purchasing candidates between them. Acquaintance engine 96 can tap into a stock 98 of available purchase offers to see if any of those line up with the candidate products. If a bulk product purchasing opportunity is found, the offer is generated for the group and transmitted electronically to each of the acquaintances via any conventional means such as email, social networking accounts, text messaging (Short Messaging Service), or customized apps for this eCommerce retailer. The offer can include multiple options for dynamic delivery locations, including a split delivery option.

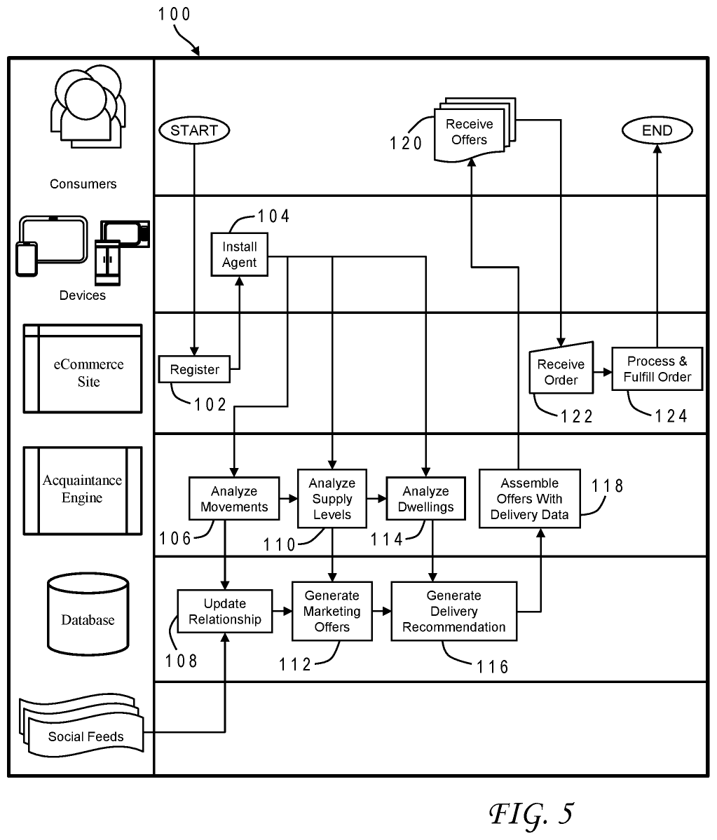

The present invention may be further understood by reference to the chart of FIG. 5 which illustrates the logical flow for a bulk product purchase optimization process 100 in accordance with one implementation of the present invention. Process 100 begins with the consumer registering at the eCommerce site 102. This registration can include identifying all of the consumer's IoT devices as well as granting permission to monitor the consumer's IoT device usage. Local software agents that support the system can be installed on any or all of the registered IoT devices 104. Movements and/or locations of the devices from multiple consumers are analyzed by the acquaintance engine to determine potential geographic areas common to two or more consumers 106. This analysis leads to possible or verified associations between certain consumers, and those relationships are updated in the database 108. Supply levels for various products used by the consumers are also analyzed 110, and used to generate potential bulk marketing offers 112. The acquaintance engine further analyzes information regarding specific locations for the consumers such as dwellings or work spaces 114. This analysis is used to generate at least one recommendation for a dynamic delivery location 116. The offer(s) and associated dynamic delivery location(s) are assembled as a bulk purchasing offer 118. The acquaintances receive the offer(s) and select any they desire for delivery 120. Once the eCommerce site receives the order 122, it processes and fulfills it 124, i.e., by delivering the bulk product to the dynamic delivery location. This processing can include determining a preferred delivery time for the bulk delivery based on prior activity of the particular acquaintance who might be receiving the delivery, e.g., at home after work hours but before bedtime.

The present invention thus provides a superior method for optimizing bulk product purchases among groups of associated individuals. The method leverages existing Internet-of-Things technologies as well as the explosive social media market to bring customers together in a way heretofore unknown. Generation of the dynamic delivery location also makes the process much more attractive to consumers. The present invention thereby creates a huge eCommerce collaboration opportunity for all players in the market. The result is a win-win situation for both consumers and eCommerce retailers.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. A method of optimizing a bulk product purchase comprising:
identifying a plurality of consumers who are acquaintances based on electronic device usage of each of the acquaintances;
establishing that each of the acquaintances has an association with a common geographic area;
determining a common product likely to be purchased on an ecommerce website by each of the acquaintances by assessing metadata obtained from online searches, historical purchase rates, consumption rates, and marketing offers associated with the acquaintances;
determining a dynamic delivery location within the common geographic area for bulk delivery of the common product;
providing a bulk purchase offer of the common product to at least one of the acquaintances based, at least in part, on the metadata obtained from the online searches, the historical purchase rates, the consumption rates, and the marketing offers associated with the acquaintances, wherein the bulk purchase offer includes the dynamic delivery location; and
receiving a purchase confirmation of the bulk purchase offer from the at least one acquaintance.

2. The method of claim 1 wherein the dynamic delivery location is based in part on one or more characteristics of the common product.

3. The method of claim 1 wherein the dynamic delivery location is based in part on one or more available facilities of the acquaintances located in the common geographic area.

4. The method of claim 1 wherein the bulk purchase offer is dynamically generated in real-time in response to said ascertaining.

5. The method of claim 1 wherein the dynamic delivery location is associated with a specific one of the acquaintances, and further comprising computing a delivery time for the bulk delivery based on prior activity of the specific acquaintance taking place within the geographic area.

6. The method of claim 1 wherein said determining determines two dynamic delivery locations for split delivery of the bulk delivery.

7. The method of claim 1 further comprising delivering the bulk delivery to the dynamic delivery location.

8. A computer system comprising:
one or more processors which process program instructions;
a memory device connected to said one or more processors; and
program instructions residing in said memory device for optimizing a bulk product purchase by:
identifying a plurality of consumers who are acquaintances based on electronic device usage of each of the acquaintances;
establishing that each of the acquaintances has an association with a common geographic area;
determining a common product likely to be purchased on an ecommerce website by each of the acquaintances by assessing metadata obtained from online searches, historical purchase rates, consumption rates, and marketing offers associated with the acquaintances;
determining a dynamic delivery location within the common geographic area for bulk delivery of the common product;
providing a bulk purchase offer of the common product to at least one of the acquaintances based, at least in part, on the metadata obtained from the online searches, the historical purchase rates, the consumption rates, and the marketing offers associated with the acquaintances, wherein the bulk purchase offer includes the dynamic delivery location; and
receiving a purchase confirmation of the bulk purchase offer from the at least one acquaintance.

9. The computer system of claim 8 wherein the dynamic delivery location is based in part on one or more characteristics of the common product.

10. The computer system of claim 9 wherein the characteristics include one or more of refrigerated, volume, weight or expiration date.

11. The computer system of claim 8 wherein the dynamic delivery location is based in part on one or more available facilities of the acquaintances located in the geographic area.

12. The computer system of claim 8 wherein the bulk purchase offer is dynamically generated in real-time in response to the ascertaining.

13. The computer system of claim 8 wherein the dynamic delivery location is associated with a specific one of the acquaintances, and further comprising computing a delivery time for the bulk delivery based on prior activity of the specific acquaintance taking place within the geographic area.

14. The computer system of claim 8 wherein the determining determines two dynamic delivery locations for split delivery of the bulk delivery.

15. A computer program product comprising:
one or more non-transitory computer readable storage media; and
program instructions collectively residing in said one or more non-transitory computer readable storage media for:
optimizing a bulk product purchase by identifying a plurality of consumers who are acquaintances based on electronic device usage of each of the acquaintances;
establishing that each of the acquaintances has an association with a common geographic area;
determining a common product likely to be purchased on an ecommerce website by each of the acquaintances by assessing metadata obtained from online searches, historical purchase rates, consumption rates, and marketing offers associated with the acquaintances;
determining a dynamic delivery location within the common geographic area for bulk delivery of the common product;
providing a bulk purchase offer of the common product to at least one of the acquaintances based, at least in part, on the metadata obtained from the online searches, the historical purchase rates, the consumption rates, and the marketing offers associated with the acquaintances, wherein the bulk purchase offer includes the dynamic delivery location; and
receiving a purchase confirmation of the bulk purchase offer from the at least one acquaintance.

16. The computer program product of claim 15 wherein the dynamic delivery location is based in part on one or more characteristics of the common product.

17. The computer program product of claim 15 wherein the dynamic delivery location is based in part on one or more available facilities of the acquaintances located in the geographic area.

18. The computer program product of claim 15 wherein the bulk purchase offer is dynamically generated in real-time in response to the ascertaining.

19. The computer program product of claim 15 wherein the dynamic delivery location is associated with a specific one of the acquaintances, and further comprising computing a delivery time for the bulk delivery based on prior activity of the specific acquaintance taking place within the geographic area.

20. The computer program product of claim 15 wherein the determining determines two dynamic delivery locations for split delivery of the bulk delivery.
